(19) United States
(12) Patent Application Publication
(10) Pub. No.: US 2020/0219396 A1
(43) Pub. Date: Jul. 9, 2020

(54) AUTOMATED DETECTION OF TRAFFIC INCIDENTS VIA INTELLIGENT INFRASTRUCTURE SENSORS

(71) Applicant: Continental Automotive Systems, Inc., Auburn Hills, MI (US)

(72) Inventors: Jesse Aaron Hacker, West Bloomfield, MI (US); Vivian Swan, Auburn Hills, MI (US)

(73) Assignee: Continental Automotive Systems, Inc., Auburn Hills, MI (US)

(21) Appl. No.: 16/735,323

(22) Filed: Jan. 6, 2020

Related U.S. Application Data
(60) Provisional application No. 62/789,796, filed on Jan. 8, 2019.

(51) Int. Cl. G08G 1/16; G08G 1/01

(52) U.S. Cl. CPC G08G 1/164; G08G 1/0141; G08G 1/0133; G08G 1/166

(57) ABSTRACT

An infrastructure-based warning system, includes: a first detection device; a detection area, the first detection device operable for detecting at least one of the location, speed, and direction of each of a plurality of objects in the detection area and to determine when a traffic incident has occurred within the detection area; a communication device operable to send at least one communication signal based upon the determined traffic incident by the first detection device.

### CROSS REFERENCE TO RELATED APPLICATIONS

This U.S. patent application claims the benefit of U.S. provisional patent application No. 62/789,796, filed Jan. 8, 2019, which is hereby incorporated by reference.

### FIELD OF THE INVENTION

The invention relates generally to a system for detecting real time or near real time data of a traffic event, such as an accident. The system is able to be integrated into local infrastructure, and is able to detect vehicles and objects which may not be readily visible to other drivers.

### BACKGROUND OF THE INVENTION

Currently, there are many types of systems in place, which are part of a vehicle, to make a driver of the vehicle aware of potential dangers with regard to collisions with pedestrians, other vehicles, and other objects along the side of a road, or on a road. Even with all of these advances in technology, accidents at both signalized and unsignalized intersections still occur.

Some vehicles are equipped with vehicle sensors that can currently detect collisions and alert first responders via services, which still require a human element in the service call center to route the emergency to the responders. Not all vehicles are equipped with such equipment and these services often come with a subscription fee which must be paid by the vehicle owner.

One of the solutions to prevent accidents at various intersections is the implementation of sensors and other types of detection devices at intersections which are used to identify the location and direction of various pedestrians and vehicles.

Accordingly, there exists a need for a system for detecting accidents at an intersection based on an automated nature, which does not rely on human elements to identify the accident, and/or alert first responders.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One general aspect includes an infrastructure-based warning system, including: a first detection device; a detection area, the first detection device operable for detecting at least one of the location, speed, and direction of each of a plurality of objects in the detection area and to determine when a traffic incident has occurred within the detection area; a communication device operable to send at least one communication signal based upon the determined traffic incident by the first detection device.

Implementations may include one or more of the following features. The apparatus where the traffic incident is one of a collision and a disabled vehicle.

The traffic incident is a collision when at least two of the plurality of objects are identified in sufficiently close space to one another.

The traffic incident is a disabled vehicles when the plurality of objects are identified as avoiding an area which is normally operational.

The communication device sends the signal to at least one first responder service and at least one vehicle proximate to the detection area.

The communication device sends the signal to at least one vehicle on a roadway approaching the detection area.

The detection device further may include on of: a camera, a radar, a lidar, a ladar, ultrasound, and sonar.

The detection device and the communication device are connected to the at least one infrastructure component.

The at least one infrastructure component being one selected from the group may include of a building, a bridge, a parking structure, and a support structure.

One general aspect includes a method for providing a warning from an accident detection and warning. The method also includes detecting at least one of the location, speed, and direction of each of a plurality of objects in a detection area of an intersection with at least one detection device. The method also includes determining a traffic incident has occurred based upon the detecting of each of the plurality of objects in the detection area with the detecting device. The method also includes generating a signal with a communication device to provide a warning that the traffic incident is detected.

Implementations may include one or more of the following features. The method may include determining a traffic incident has occurred when at least two of the plurality of objects are identified in sufficiently close space to one another.

The method may include determining a traffic incident has occurred when the plurality of objects are identified as avoiding an area which is normally operational.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present invention will become more fully understood from the detailed description and the accompanying drawings, wherein:

FIG. 1 is a diagram of a first example of an accident detection and warning system, according to embodiments of the present invention;

FIG. 2 is a diagram of a second example of an accident detection and warning system, according to embodiments of the present invention; and

FIG. 3 is a flow diagram of an example method for implementing accident detection and warning system, according to embodiments of the present invention.

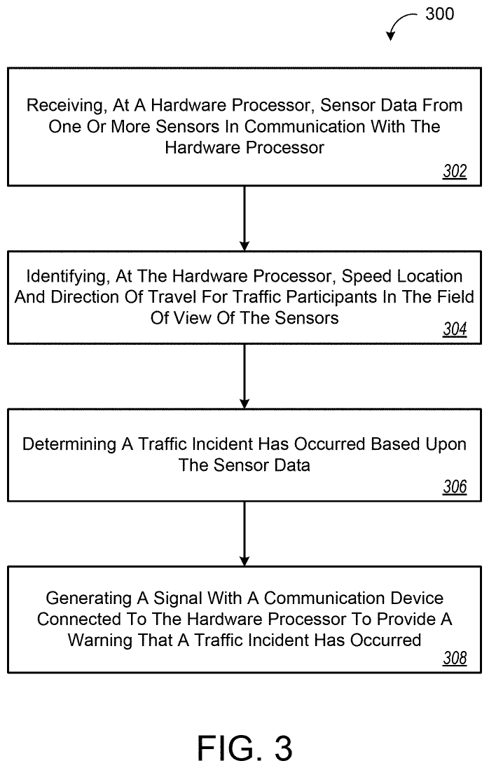

### DETAILED DESCRIPTION OF THE PREFERRED EMBODIMENTS

The following description of the preferred embodiment(s) is merely exemplary in nature and is in no way intended to limit the invention, its application, or uses.

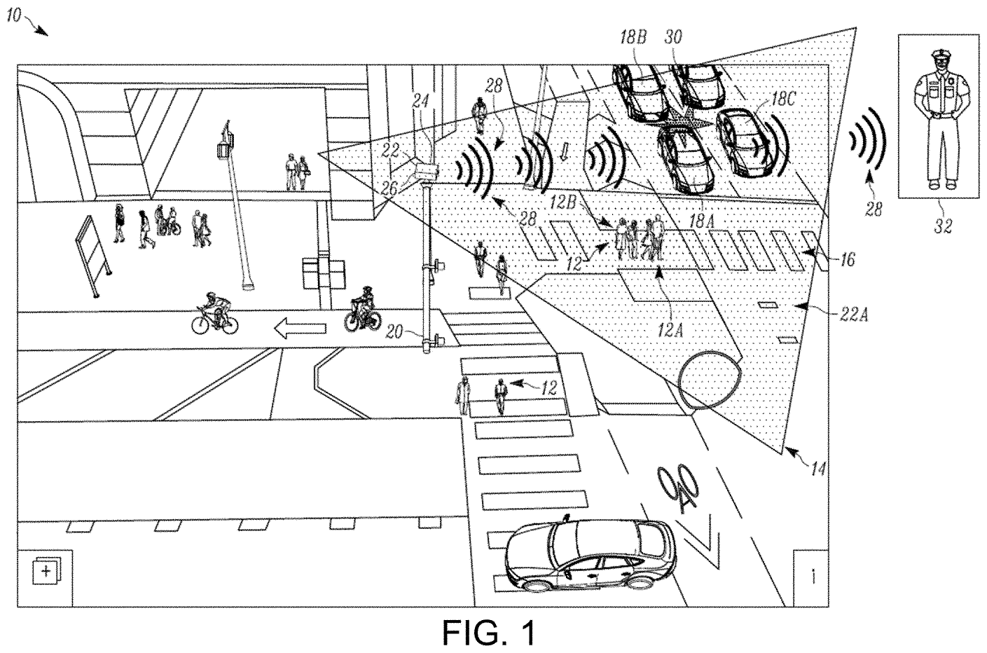

The present invention is a system for detecting objects using various types of detection devices, where the operation of the detection devices is optimized. The system is used as part of an intelligent intersection or intelligent road, and is used for providing a warning to various vulnerable road users (VRUs) and vehicles of potential collisions. A diagram of a first example of accident detection and warning system according to the present invention is shown in FIG. 1, generally at 10. There are also several VRUs, shown in the diagram generally at 12, travelling near an intersection, shown generally at 14. More specifically, there are two vulnerable road users 12A,12B attempting to cross the intersection 14 at a cross-walk, shown generally at 16. A first vehicle 18A is stopped near the cross-walk 14, and a second vehicle 18B has collided with the first vehicle 18A.

The warning system 10 includes some type of infrastructure component, which in this embodiment is a post, shown generally at 20, and connected to the post 20 is a first detection device 22A, a second detection device 22B, at least one communication device 24. While in this embodiment, the infrastructure component is the post 20, it is within the scope of the invention that the warning system 10 may include any other type of infrastructure component, such as a building, bridge, parking structure, support structure, or the like. In this embodiment, the detection devices 22A,22B, communication device 24 are integrated into a single component shown generally at 28 connected to the post 20, but it is within the scope of the invention that the detection devices 22A,22B, communication device 24 may be separate components in different locations located about the intersection each having differing fields of view. The detection devices 22A,22B in this embodiment are able to detect objects in a detection area, shown generally at 22C. The detection devices 22A,22B may be for example, a camera, a radar, a LIDAR (Light Imaging, Detection, and Ranging), a LADAR (Laser Imaging, Detection, and Ranging), or other types of radars, cameras, ultrasound, or sonar, etc. Both of the detection devices 22A,22B are able to detect objects in the detection area 22C.

In the example shown in the Figure, the first vehicle 18A is stopped at the intersection 14, and the second vehicle 18B has collided with the first vehicle 18A, with the impact being shown by the icon generally at 30. When the second vehicle 18B has collided with the first vehicle 18A in the detection area 22A, the collision 30 is detected by the detection devices 22A,22B, and the detection devices 22A,22B send a signal to the communication device 24, and the communication device 24 sends/broadcasts a signal and/or message, shown generally at 28, to a local law enforcement agency, represented by icon 32, such that the local law enforcement agency 32 may respond appropriately. The signal 28 may also be sent to one or more local hospitals, such that an ambulance and paramedics may be sent to the location of the collision between the vehicles 18A,18B, if necessary. Additionally, the signal/message may be broadcast to other vehicles in proximity to the intersection, or vehicles that are detected as being on road and pathways that would be approaching the intersection.

In FIG. 1, the detection devices 22A,22B are able to detect the location, as well as speed and direction of each vehicle 18A,18B, and the location, speed, and direction of each VRU 12A,12B. If there is a collision between the first vehicle 18A and the second vehicle 18B in the detection area 22C detected by the detection devices 22A,22B are able to determine that an accident has occurred.

The detection devices 22A,22B in an intersection that are part of an Intelligent Intersection may maintain a list of traffic participants, as well as their locations, and kinematic data. Algorithms in the infrastructure can currently identify potential collisions to broadcast a Basic Safety Message (BSM) or Personal Safety Message (PSM) over dedicated short range communication (DSRC) in an effort to avoid incidents. Using one or a combination of the following two examples, such a system 10 can identify crashed or disabled vehicles and report the incidents to first responders automatically.

In the first example it is possible to create an algorithm that can detect when two objects (vehicles 18A,18B) occupy a sufficiently close space to assume they have collided. For instance, sufficiently close space may include a minimum overlap, e.g. 10% or more, of space such that the objects must be in contact with each other. Alternately, sufficiently close space may simply be no detectable space between one object and another. One skilled in the art would be able to determine what is sufficiently close to detect an accident for a give warning system 10 based upon the precision and accuracy of the detection devices, 22A,22B, as well as the desired operational parameters of the system 10 operation.

In the second example, it is also possible to observe normal traffic flows over time, create a heatmap from these flows, and determine the lane usage in an intersection under normal conditions. With the knowledge of which lanes are normally used by traffic, the system 10 can determine if vehicles are avoiding a certain area or lane which is normally operational indication the presence of crashed or disabled vehicles.

Using either of these two examples or a combination thereof, the system detects and sends a message when an accident or a disabled vehicle is detected.

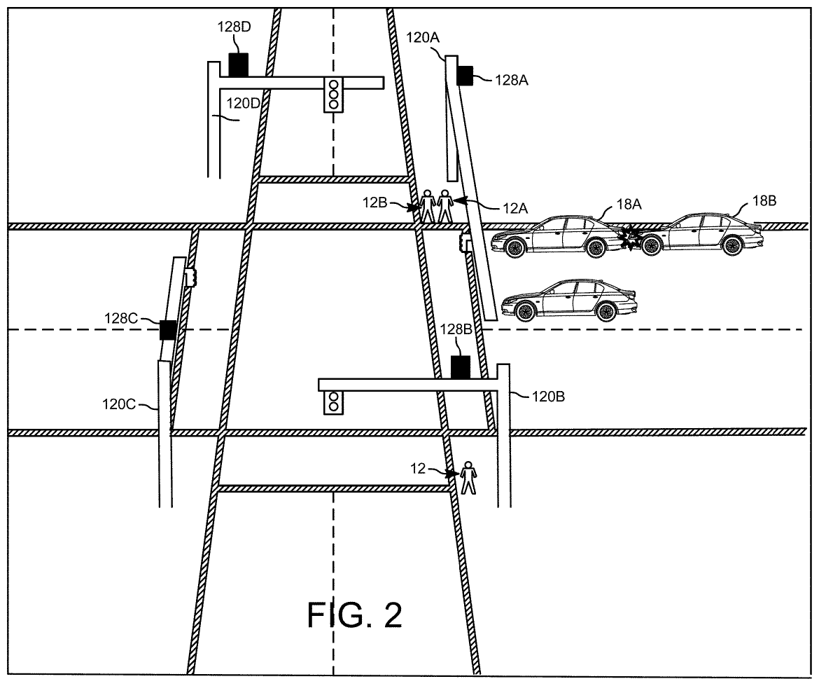

Another embodiment of the present invention having an accident detection and warning system 110 is shown in FIG. 2, with like numbers referring to like elements. However, in this embodiment, the intersection 114 includes additional posts 120A,120B,120C, and each post 120A,120B,120C includes a corresponding component 128A,128B,128C having at least one detection device 122A, 122B, 122C and a communication device 124A,124B,124C.

The detection device(s) 122A-C are able to detect the location, as well as speed and direction of each vehicle 118A,118B, and the location, speed, and direction of each VRU 112A,112B. If there is a collision between the first vehicle 118A and the second vehicle 118B in the detection area 116 detected by the detection devices 122A-D are able to determine that an accident has occurred.

The detection devices 122A-D in an intersection that are part of an Intelligent Intersection may maintain a list of traffic participants, as well as their locations, and kinematic data. Algorithms in the infrastructure can currently identify potential collisions to broadcast a BSM or PSM over DSRC in an effort to avoid incidents. Using one or a combination of the following two examples, such a system 110 can identify crashed or disabled vehicles and report the incidents to first responders automatically.

In the first example it is possible to create an algorithm that can detect when two objects (vehicles 118A,118B) occupy a sufficiently close space to assume they have collided.

In the second example, it is also possible to observe normal traffic flows over time, create a heatmap from these flows, and determine the lane usage in an intersection under normal conditions. With the knowledge of which lanes are normally used by traffic, the system 110 can determine if vehicles are avoiding a certain area or lane which is normally operational indication the presence of crashed or disabled vehicles.

Using either of these two examples or a combination thereof, the system detects and sends a message when an accident or a disable vehicle is detected.

Further in regards to both embodiments described above, the communication device 24 is a DSRC device 24, or may be a 5g communication device 24, but it is within the scope of the invention that other types of communication devices may be used.

This system 10 can use the Intelligent Intersections existing LTE connection to broadcast an alert in the event of an incident to First Responders as well as nearby traffic controllers indicating that medical/fire/police presence may be needed (in the event of particularly fast vehicle to vehicle collisions or any vehicle to pedestrian collision), and nearby traffic controllers could be programmed to attempt to lessen the flow of traffic to the intersection that just experienced the incident. Additionally, this information may be broadcast with a BSM or communicated through a PSM to other vehicle proximate to the intersection and/or approaching an intersection.

By removing the need for human response to a traffic incident, incident responses can become much quicker, especially in more sparsely populated intersections where the only witnesses able to respond may have been involved in the incident. Data on incidents may also help in diverting traffic around the affected intersection to help ease congestion and make it easier for responders to resolve the issue without having to worry about also directing traffic.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
an infrastructure-based warning system, including:
a first detection device;
a detection area, the first detection device operable for detecting at least one of the location, speed, and direction of each of a plurality of objects in the detection area and to determine when a traffic incident has occurred within the detection area;
a communication device operable to send at least one communication signal based upon the determined traffic incident by the first detection device.

2. The apparatus of claim 1, wherein the traffic incident is one of a collision and a disabled vehicle.

3. The apparatus of claim 2, wherein the traffic incident a collision when at least two of the plurality of objects are identified in sufficiently close space to one another.

4. The apparatus of claim 2, wherein the traffic incident is a disabled vehicles when the plurality of objects are identified as avoiding an area which is normally operational.

5. The apparatus of claim 1, wherein the communication device sends the signal to at least one first responder service and at least one vehicle proximate to the detection area.

6. The apparatus of claim 5, wherein the communication device sends the signal to at least one vehicle on a roadway approaching the detection area.

7. The apparatus of claim 1, the detection device further comprises on of: a camera, a radar, a LIDAR, a LADAR, ultrasound, and sonar.

8. The apparatus of claim 1, further comprising at least one infrastructure component, wherein the detection device and the communication device are connected to the at least one infrastructure component.

9. The apparatus of claim 8, the at least one infrastructure component being one selected from the group consisting of a building, a bridge, a parking structure, and a support structure.

10. A method for providing a warning from an accident detection and warning system comprising:
detecting at least one of the location, speed, and direction of each of a plurality of objects in a detection area of an intersection with at least one detection device;
determining a traffic incident has occurred based upon the detecting of each of the plurality of objects in the detection area with the detecting device;
generating a signal with a communication device to provide a warning that the traffic incident is detected.

11. The method of claim 10, further comprising determining a traffic incident has occurred when at least two of the plurality of objects are identified in sufficiently close space to one another.

12. The method of claim 10, further comprising determining a traffic incident has occurred when the plurality of objects are identified as avoiding an area which is normally operational.
